(19) United States
(12) Patent Application Publication
(10) Pub. No.: US 2008/0137244 A1
(43) Pub. Date: Jun. 12, 2008

(54) Electrostatic discharge protection circuit

(75) Inventors: Kuo-Feng Yo, Hsinchu (TW); Jian-Hsing Lee, Hsinchu (TW); Jiaw-Ren Shih, Hsinchu (TW); Fu-Chin Yang, Kaohsiung (TW)

Correspondence Address: BIRCH, STEWART, KOLASCH & BIRCH, LLP, PO BOX 747, 8110 GATEHOUSE RD, STE 500 EAST, FALLS CHURCH, VA, 22040-0747, US

(73) Assignee: TAIWAN SEMICONDUCTOR MANUFACTURING CO., LTD.

(21) Appl. No.: 11/637,108

(22) Filed: Dec. 12, 2006

(51) Int. Cl. H02H 9/00

(52) U.S. Cl. 361/56

(57) ABSTRACT

An electrostatic discharge (ESD) protection circuit. The ESD protection circuit comprises a silicon controlled rectifier (SCR) device and a metal-oxide-semiconductor (MOS) triggering device. The SCR device has a cathode connected to a first fixed potential and an anode. The MOS triggering device has a gate and a source connected to the first fixed potential and a drain connected to the anode. In addition, the MOS triggering device is not physically disposed in the SCR device.

### BACKGROUND OF THE INVENTION

1. Field of the Invention

The invention relates to electrostatic discharge (ESD) protection and, in particular, to ESD circuits comprising a silicon controlled rectifier (SCR) device and a metal-oxide-semiconductor (MOS) triggering device.

2. Description of the Related Art

Generally, to protect semiconductor chips from damage from electrostatic charge (ESD) during manufacturing, ESD protection circuits are configured between an input pad and an input stage of semiconductor chips. The ESD protection circuit remains open during normal operating mode such that the input stage and internal circuits of the semiconductor chip normally function. When the ESD occurs at an input of the ESD protection circuit, the circuit enters a short state to dissipate ESD discharge, protecting internal circuits of the semiconductor chips.

FIG. 1A shows a layout of a conventional ESD protection circuit 100. The conventional ESD protection circuit 100 comprises a silicon controlled rectifier (SCR) device 110 and a n-type metal-oxide-semiconductor (NMOS) triggering device 120. FIG. 1B is a cross section of the ESD protection circuit 100 in FIG. 1A. As shown in FIGS. 1A and 1B, the SCR device 110 comprises a P-type heavily doped region 111, an N-well 112 surrounding the p-type heavily doped region 111, a P-type substrate 113 surrounding the N-well 112, and an N-type doped region 114 in the P-type substrate 113. The triggering NMOS device 120 is disposed between the N-well 112 and the P+ guard ring 113. A parasitic bipolar junction transistor (BJT) npn′ of the triggering NMOS device 120 is formed over a parasitic BJT npn of the SCR device 110. A source 114 and a gate 122 of the triggering NMOS device 120 and the P+ guard ring 113 are connected to a fixed potential Vss. The drain 123, the P-type substrate P-sub, and the P-type heavily doped region 111 are connected an input pad PAD. In addition, the ESD protection circuit 100 may further comprise an N+ guard ring 130 surrounding the P+ guard ring 113. The N+ guard ring 130 is connected to a fixed potential Vcc.

FIGS. 2A˜2D are circuit diagrams showing applications of the ESD protection circuit 100 in FIG. 1A. In FIG. 2A, the ESD protection circuit 100 has one end connected to a pad PAD and an input stage 210 and the other end connected to a fixed potential Vss. FIG. 2B differs from FIG. 2A in that a 10Ω resistor R is connected between the ESD protection circuit and an input node 211 of the input stage 210. FIG. 2C differs from FIG. 2A in that a second ESD protection device is connected between the input node 211 of the input stage 210 and the fixed potential Vss. FIG. 2D differs from FIG. 2A in that a 10Ω resistor R is connected between the ESD protection circuit and an input node 211 of the input stage 210 and a second ESD protection device is connected between the input node 211 of the input stage 210 and the fixed potential Vss. ESD testing results show that structures shown in FIGS. 2B and 2C are more robust than those shown in FIG. 2A and the structure shown in FIG. 2D is more robust than those in FIGS. 2A˜2C. In other words, the ESD protection circuit may require additional resistor or a second ESD protection device to accomplish ESD protection.

### BRIEF SUMMARY OF THE INVENTION

An embodiment of an electrostatic discharge (ESD) protection circuit comprises a silicon controlled rectifier (SCR) device and a metal-oxide-semiconductor (MOS) triggering device. The SCR device has a cathode connected to a first fixed potential and an anode. The MOS triggering device has a gate and a source connected to the first fixed potential and a drain connected to the anode. In addition, the MOS triggering device is not physically disposed in the SCR device.

An embodiment of an integrated circuit comprises the disclosed ESD protection circuit, an input pad, and an input stage. The anode of the SCR device is connected to the input pad and the input stage.

An embodiment of an integrated circuit comprises the disclosed ESD protection circuit, a core circuitry. The core circuitry is protected by the ESD protection circuit.

The invention provides an ESD protection circuit comprising a SCR device and a MOS triggering device. The MOS triggering device, not physically disposed in the SCR device and does not dominate current discharge after the SCR device is turned on in an ESD event, and thus receiving only minimal current after the SCR device is turned on, is protected from damage by ESD pulses, resulting in more robust ESD protection.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A shows a layout of a conventional ESD protection circuit;

FIG. 1B is a cross section of the ESD protection circuit in FIG. 1A;

FIGS. 2A˜2D are circuit diagrams showing applications of the ESD protection circuit in FIG. 1A;

FIG. 3A shows a layout of an ESD protection circuit according to an embodiment of the invention;

FIG. 3B is a cross section of the ESD protection circuit in FIG. 3A;

FIG. 4 is a circuit diagram showing an application of the ESD protection circuit in FIG. 3A.

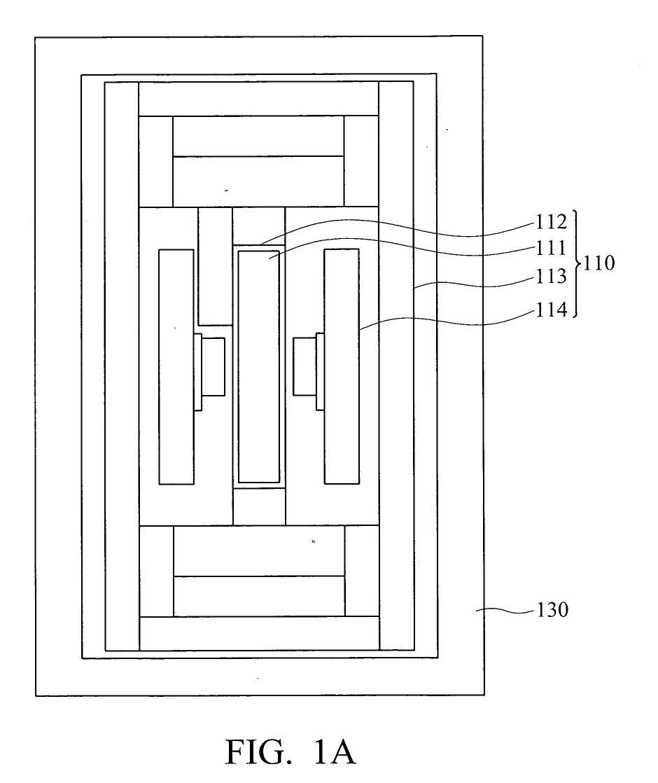

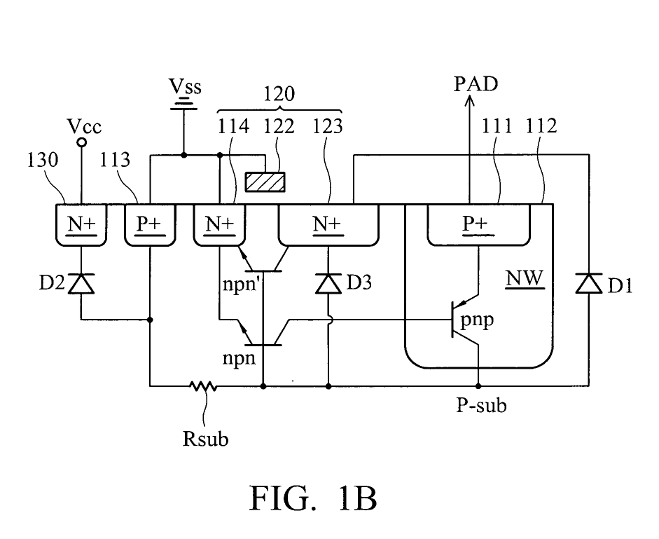

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

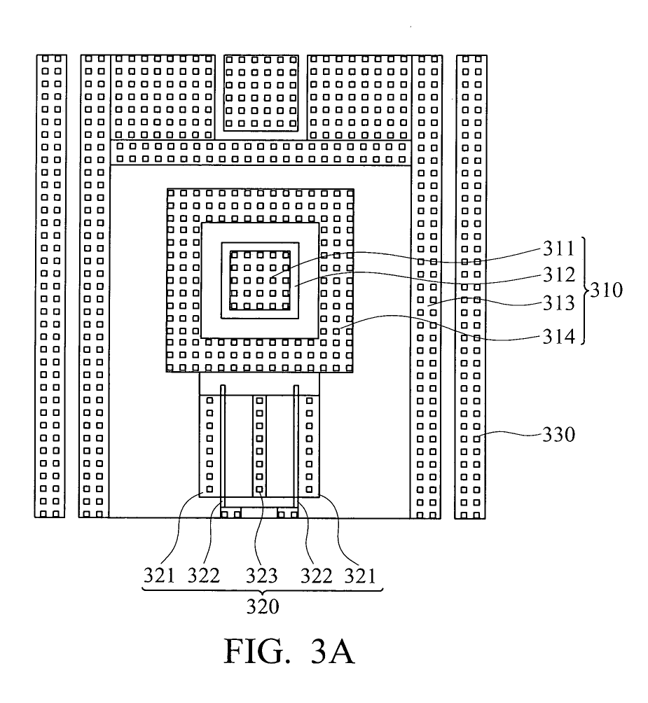

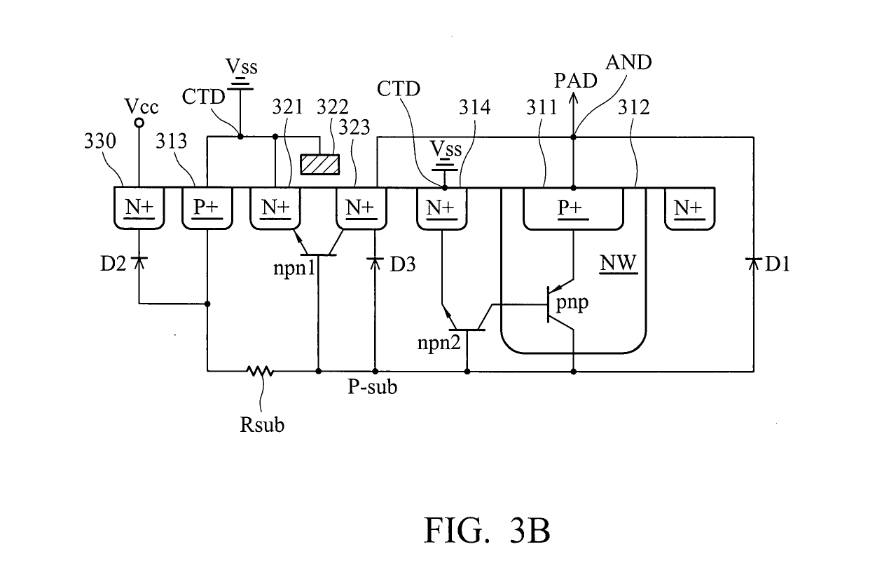

FIG. 3A shows a layout of an ESD protection circuit 300 according to an embodiment of the invention. The ESD protection circuit 300 comprises a silicon controlled rectifier (SCR) device 310 and a metal-oxide-semiconductor (MOS) triggering device 320. FIG. 3B is a cross section of the ESD protection circuit in FIG. 3A. As shown in FIGS. 3A and 3B, the SCR device 310 has a cathode CTD connected to a first fixed potential and an anode AND. The MOS triggering device 320 has a gate 322 and a source 321 connected to the first fixed potential and a drain 323 connected to the anode AND. More specifically, the first fixed potential is a fixed potential Vss. In addition, the MOS triggering device 320 is not physically disposed in the SCR device 310. In other words, from a perspective of layout, the MOS triggering device 320 is not substantially surrounded or enclosed by the SCR device 310.

In FIGS. 3A and 3B, the SCR device 310 comprises a P-type heavily doped region 311 acting as the anode AND, an N-well 312 surrounding the P-type heavily doped region 311, an N-type heavily doped region 314 acting as the cathode CTD and surrounding the N-well 312, and a P+ guard ring 313 surrounding the N-type heavily doped region 314. The P-type heavily doped region 311 is disposed in the N-well 312 and the N-well 312 in a P-type substrate P-sub connected to the fixed potential Vss via the P+ guard ring 313. To lower capacitance associated with the ESD protection circuit 300, P-type heavily doped region 311 is laid out as a square such that perimeter of the P+/N-well junction capacitance is minimized within the same area of P+/N-well. The MOS triggering device 320 is an N-type metal-oxide-semiconductor (nMOS) device disposed outside the N-type heavily doped region 314. The drain 323, the P-type substrate P-sub, and the P-type heavily doped region 311 are connected an input pad PAD. The ESD protection circuit 300 may further comprise an N+ guard ring 330 surrounding the P+ guard ring 313. The N+ guard ring 330 is connected to a second fixed potential. More specifically, the second fixed potential is a fixed potential Vcc.

In the ESD protection circuit 300 according to the embodiment of the invention, the MOS triggering device 320 is not in a transversal current path of the SCR device 310. After the SCR device 310 is triggered and turned on by the MOS triggering device 320, most ESD discharge current no longer flows through the MOS triggering device 320. As a result, the MOS triggering device is not damaged by ESD pulses and ESD protection is more robust.

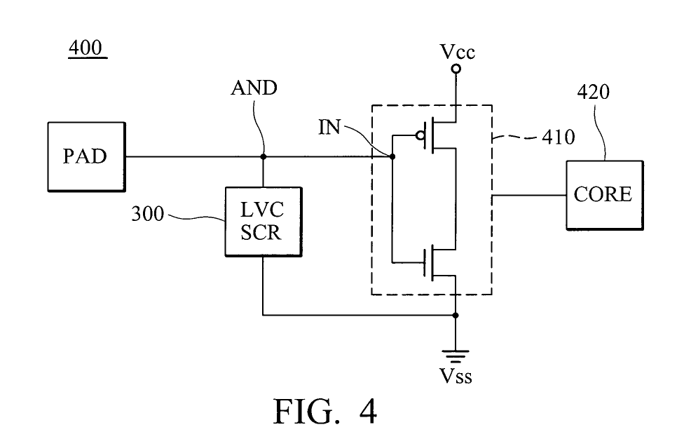

FIG. 4 is a circuit diagram showing an application of the ESD protection circuit in FIG. 3A. An embodiment of an integrated circuit 400 of the invention comprises the disclosed ESD protection circuit 300, an input pad PAD, an input stage 410 having an input node connected to the input pad PAD, and a core circuitry 420 connected to the input stage 410. The anode AND of the SCR device 300 is connected to the input pad PAD and the input stage 410. In FIG. 4, the input stage 410 is an inverter comprising a PMOS transistor and an NMOS transistor cascoded between fixed potentials Vcc and Vss. However, the scope of the input stage 410 is not limited thereto.

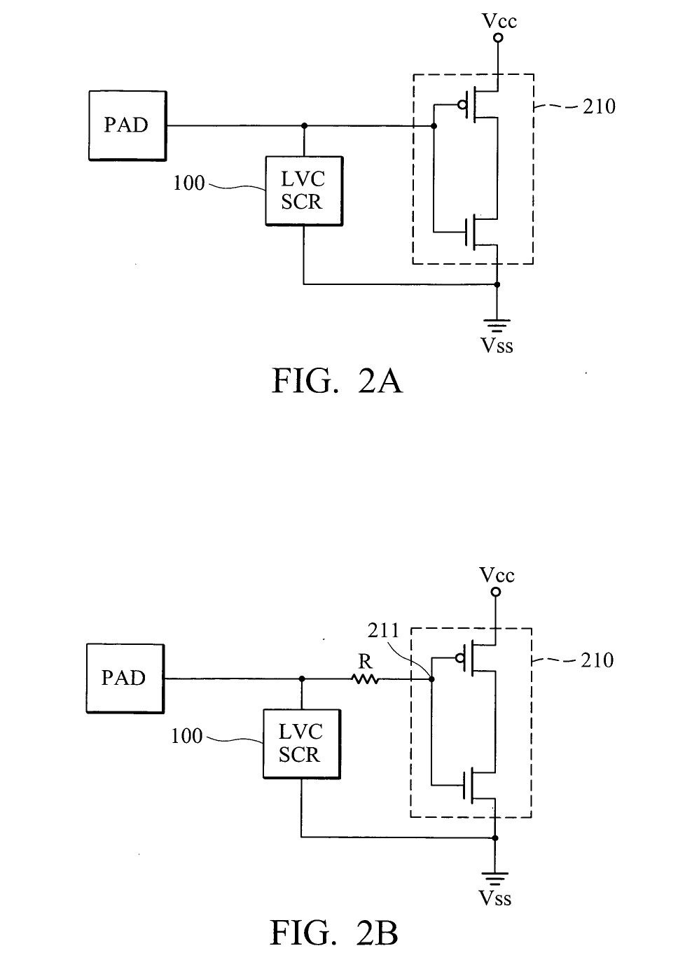

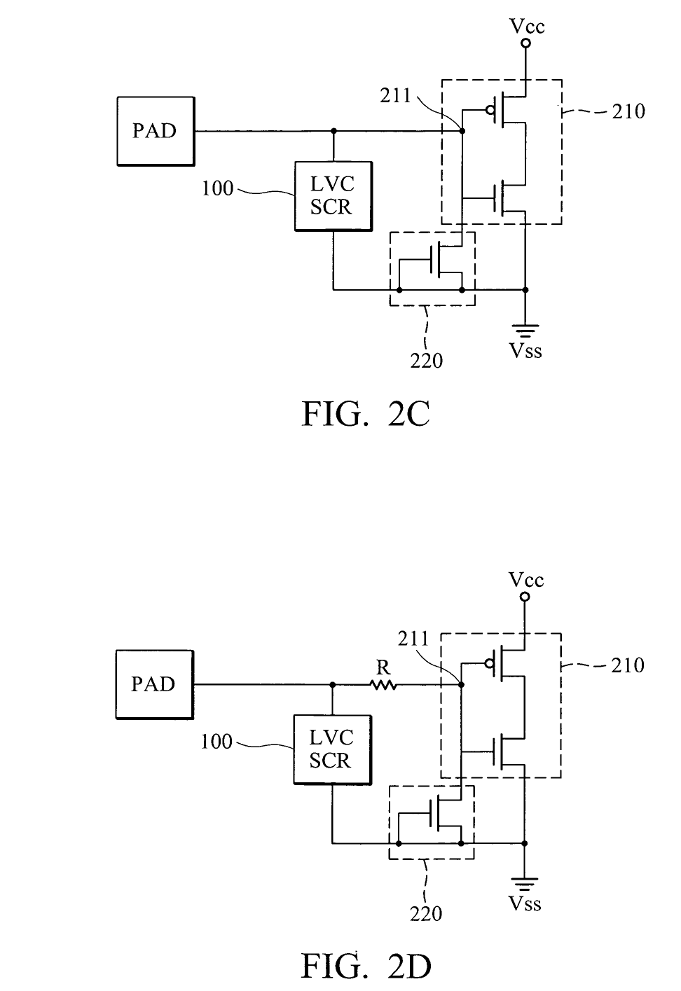

Tables I and II show experimental results of ESD testing for applications of a conventional ESD protection circuit and an ESD protection circuit according to an embodiment of the invention. Table I shows experimental results of ESD testing for structures in FIGS. 2A˜2D under human body mode (HBM) and machine mode (MM). Table II shows experimental results of ESD testing for a structure in FIG. 4 under human body mode (HBM) and machine mode (MM) with ESD protection circuits SCR-1N, SCR-2N, and SCR-3N of three sizes. Generally, an ESD pulse voltage criteria is 2 KV to pass a HBM ESD testing and 200V to pass a MM ESD testing. The structure in FIG. 4 differs from that in FIG. 2A only in ESD protection circuits. ESD performance of the structure in FIG. 4 with the ESD protection circuit SCR-3N is improved over that of the structure in FIG. 2A. In addition, the structure in FIG. 4 with the ESD protection circuit SCR-3N almost passes every ESD test in under human body mode (HBM) and machine mode (MM) and capacitance associated with the ESD protection circuit SCR-3N is only 109.88 fF. Such low capacitance due to square layout of the P-type heavily doped region has negligible impact on normal operation at high speeds in the input stage and internal circuits. Furthermore, no additional input resistor and second ESD protection device is required to improve ESD protection.

TABLE I

| | FIG. 2A | | FIG. 2B | | FIG. 2C | | FIG. 2D | |
|---|---|---|---|---|---|---|---|---|
| HBM(+/Vss) | +1.5 | KV | +2.5 | KV | +0.25 | KV | +5.5 | KV |
| HBM(−/Vss) | −6.0 | KV | −6.0 | KV | −6.5 | KV | −6.0 | KV |
| HBM(+/Vcc) | +1.5 | KV | +2.5 | KV | +0.25 | KV | +5.0 | KV |
| HBM(−/Vcc) | −1.5 | KV | −1.5 | KV | −2.0 | KV | −3.0 | KV |
| MM(+/Vss) | +50 | V | +100 | V | <25 | V | +400 | V |
| MM(−/Vss) | −400 | V | −400 | V | −425 | V | −400 | V |
| MM(+/Vcc) | +75 | V | +100 | V | +25 | V | +375 | V |
| MM(−/Vcc) | −100 | V | −75 | V | −125 | V | −400 | V |

TABLE II

| | SCR-1N | | SCR-2N | | SCR-3N | |
|---|---|---|---|---|---|---|
| capacitance | 79.74 | fF | 99.14 | fF | 109.88 | fF |
| +HBM/Vss | 1 | KV | 2.0 | KV | 3.0 | KV |
| −HBM/Vss | −1.5 | KV | −2.0 | KV | −3.0 | KV |
| +MM/Vss | +50 | V | +75 | V | +175 | V |
| −MM/Vss | −75 | V | −175 | V | −200 | V |

The invention provides an ESD protection circuit comprising a SCR device and a MOS triggering device. The MOS triggering device, not physically disposed in the SCR device and does not dominate current discharge after the SCR device is turned on in an ESD event, and thus receiving only minimal current after the SCR device is turned on, is protected from damage by ESD pulses, resulting in more robust ESD protection.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An electrostatic discharge (ESD) protection circuit, comprising:
a silicon controlled rectifier (SCR) device having a cathode connected to a first fixed potential and an anode; and
a metal-oxide-semiconductor (MOS) triggering device having a gate and a source connected to the first fixed potential and a drain connected to the anode;
wherein the MOS triggering device is not physically disposed in the SCR device.

2. The ESD protection circuit as claimed in claim 1, wherein the SCR device comprises a P-type heavily doped region corresponding to the anode, an N-well surrounding the P-type heavily doped region, an N-type heavily doped region corresponding to the cathode and surrounding the N-well, and a P+ guard ring surrounding the N-type heavily doped region.

3. The ESD protection circuit as claimed in claim 2, wherein the layout of the P-type heavily doped region is square.

4. The ESD protection circuit as claimed in claim 2, wherein the MOS triggering device is an N-type metal-oxide-semiconductor (nMOS) device and is disposed outside the N-type heavily doped region.

5. The ESD protection circuit as claimed in claim 4, further comprising a N+ guard ring outside the P+ guard ring and connected to a second fixed potential.

6. An integrated circuit, comprising:
an input pad;
an input stage having an input node connected to the input pad; and
an ESD protection circuit, comprising:
a silicon controlled rectifier (SCR) device having a cathode connected to a first fixed potential and an anode connected to the input pad and the input node; and
a metal-oxide-semiconductor (MOS) triggering device having a gate and a source connected to the first fixed potential and a drain connected to the anode;
wherein the MOS triggering device is not physically disposed in the SCR device.

7. The integrated circuit as claimed in claim 6, wherein the SCR device comprises a P-type heavily doped region corresponding to the anode, an N-well surrounding the P-type heavily doped region, an N-type heavily doped region corresponding to the cathode and surrounding the N-well, and a P+ guard ring surrounding the N-type heavily doped region.

8. The integrated circuit as claimed in claim 7, wherein the layout of the P-type heavily doped region is square.

9. The integrated circuit as claimed in claim 7, wherein the MOS triggering device is an N-type metal-oxide-semiconductor (nMOS) device and is disposed outside the N-type heavily doped region.

10. The integrated circuit as claimed in claim 9, further comprising a N+ guard ring outside the P+ guard ring and connected to a second fixed potential.

11. The integrated circuit as claimed in claim 6, wherein the input stage is coupled between the first fixed potential and a second fixed potential.

12. An integrated circuit, comprising:
an ESD protection circuit, comprising:
a silicon controlled rectifier (SCR) device having a cathode connected to a first fixed potential and an anode; and
a metal-oxide-semiconductor (MOS) triggering device having a gate and a source connected to the first fixed potential and a drain connected to the anode; and
a core circuitry, protected by ESD protection circuit;
wherein the MOS triggering device is not physically disposed in the SCR device.

13. The integrated circuit as claimed in claim 12, wherein the SCR device comprises a P-type heavily doped region corresponding to the anode, an N-well surrounding the P-type heavily doped region, an N-type heavily doped region corresponding to the cathode and surrounding the N-well, and a P+ guard ring surrounding the N-type heavily doped region.

14. The integrated circuit as claimed in claim 13, wherein the layout of the P-type heavily doped region is square.

15. The integrated circuit as claimed in claim 13, wherein the MOS triggering device is an N-type metal-oxide-semiconductor (nMOS) device and is disposed outside the N-type heavily doped region.

16. The integrated circuit as claimed in claim 15, further comprising a N+ guard ring outside the P+ guard ring and connected to a second fixed potential.

17. The integrated circuit as claimed in claim 12, further comprising an input pad, and an input stage, wherein the anode of the SCR device is connected to the input pad and the input stage and the core circuitry is connected to the input stage.

18. The integrated circuit as claimed in claim 17, wherein the input stage is coupled between the first fixed potential and a second fixed potential and to the core circuitry.
